(19) United States
(12) Patent Application Publication
(10) Pub. No.: US 2026/0210074 A1
(43) Pub. Date: Jul. 23, 2026

(54) Rotatable Machinery Mount

(71) Applicant: K Bellavance Land Works, LLC, Barre, VT (US)

(72) Inventors: Kyle Bellavance, Barre, VT (US); Charles Atwood, Barre, VT (US)

(73) Assignee: K Bellavance Land Works, LLC, Barre, VT (US)

(21) Appl. No.: 19/450,512

(22) Filed: Jan. 15, 2026

Related U.S. Application Data
(60) Provisional application No. 63/746,397, filed on Jan. 17, 2025.

(51) Int. Cl. E02F 3/96; B66D 1/28

(52) U.S. Cl. CPC E02F 3/963; B66D 1/28

(57) ABSTRACT

An equipment mounting apparatus includes a frame with an alignment ring attached to a top surface and an anchor point attached to a bottom surface. The alignment ring captures an alignment disc and allows the alignment disc to rotate relative to the alignment ring. The alignment ring is capable of receiving an arm bracket. The top surface of the frame contains a circular pattern of alignment holes positioned below and concentric to the alignment disc. The alignment disc includes at least two disc holes that align with the circular pattern of alignment holes in the frame. The alignment disc is rotatably positionable relative to the frame and reversibly affixable in position with fasteners placed through the disc holes and alignment holes to enable a yaw adjustment of the alignment disc relative to the frame.

### CROSS-REFERENCE TO RELATED APPLICATION

The present application claims priority to U.S. Provisional Application 63/746,397, filed Jan. 17, 2025, and titled Rotatable Machinery Mount, which is hereby incorporated herein by reference.

### BACKGROUND

The present application relates to devices which mount to machinery such as excavators; in particular, to devices that removably attach to the end of an excavator arm and provide adjustability of the position or rotational orientation of such a device relative to the excavator arm.

### SUMMARY

The disclosure also provides support for an equipment mounting apparatus, comprising: a frame that includes an alignment ring attached to a top surface of the frame, and an anchor point attached to a bottom surface of the frame, the alignment ring configured to capture an alignment disc and allow the alignment disc to rotate relative to the alignment ring, the alignment ring capable of receiving an arm bracket, the top surface of the frame containing a circular pattern of alignment holes positioned below and concentric to the alignment disc, the alignment disc including at least two disc holes that align with the circular pattern of alignment holes in the frame, and the alignment disc being rotatably positionable relative to the frame and reversibly affixable in position with fasteners placed through the disc holes and alignment holes to enable a yaw adjustment of the alignment disc relative to the frame. In a first example of the system in which the alignment disc includes four disc holes arranged in a rectangular pattern on the alignment disc. In a second example of the system, optionally including the first example in which the alignment ring includes a recess on an interior circumference of the alignment ring, the recess configured to receive and capture the alignment disc. In a third example of the system, optionally including one or both of the first and second examples in which the alignment disc has an outer diameter larger than an inner opening diameter of the alignment ring to prevent the alignment disc from passing through the alignment ring while allowing rotational movement. In a fourth example of the system, optionally including one or more or each of the first through third examples in which an arm bracket is mounted to the alignment ring. In a fifth example of the system, optionally including one or more or each of the first through fourth examples in which a winch is mounted to the top surface of the frame. In a sixth example of the system, optionally including one or more or each of the first through fifth examples in which the anchor point is configured to penetrate ground and provide bracing force when a winch cable of the winch is under tensile load. In a seventh example of the system, optionally including one or more or each of the first through sixth examples in which the arm bracket is attachable to an arm of an excavator. In a eighth example of the system, optionally including one or more or each of the first through seventh examples in which the alignment ring is bolted to the top surface of the frame. In a ninth example of the system, optionally including one or more or each of the first through eighth examples in which the circular pattern of alignment holes provides multiple discrete rotational positions for the alignment disc.

The disclosure also provides support for an equipment mounting system for an excavator, comprising: an excavator arm, a frame having a top surface and a bottom surface, an alignment ring affixed to the top surface of the frame, an alignment disc captured within the alignment ring and rotatable relative to the alignment ring, an arm bracket having a first portion removably attached to an end of the excavator arm and a second portion affixed to the alignment disc, a plurality of disc holes in the alignment disc configured to align with the circular pattern of alignment holes, an anchor point extending from the bottom surface of the frame, and the top surface of the frame capable of receiving a winch, the alignment disc being rotatably positionable to align the disc holes with different sets of alignment holes in the circular pattern to enable a yaw adjustment of the frame and winch relative to the excavator arm without repositioning the excavator. In a first example of the system in which the alignment ring includes a recess on an interior circumference that captures the alignment disc while permitting rotational movement. In a second example of the system, optionally including the first example in which the plurality of disc holes comprises four disc holes. In a third example of the system, optionally including one or both of the first and second examples in which the anchor point is configured to penetrate ground and transfer winching loads into the ground. In a fourth example of the system, optionally including one or more or each of the first through third examples in which the alignment disc is secured in a selected rotational position by disc fasteners extending through the disc holes and into the alignment holes. In a fifth example of the system, optionally including one or more or each of the first through fourth examples in which each alignment hole is threaded to engage with a disc fastener. In a sixth example of the system, optionally including one or more or each of the first through fifth examples in which the circular pattern of angular holes provides a plurality of discrete angular positions for the frame relative to the excavator arm.

The disclosure also provides support for a method of adjusting a pull angle of a winch mounted on an excavator, comprising: providing an equipment mounting apparatus comprising a frame with an alignment ring affixed to a top surface of the frame, an alignment disc captured within the alignment ring, an arm bracket attached to the alignment disc and removably attached to an excavator arm, and a winch mounted to the top surface of the frame, removing disc fasteners securing the alignment disc in a first rotational position relative to the frame, rotating the alignment disc within the alignment ring to a second rotational position relative to the frame to adjust a yaw angle of the frame and winch relative to the excavator arm, and installing fasteners through disc holes in the alignment disc and alignment holes in the frame to secure the alignment disc in the second rotational position. In a first example of the method, the method further comprises: penetrating ground with an anchor point extending from a bottom surface of the frame to provide bracing during winching operations. In a second example of the method, optionally including the first example rotating the alignment disc comprising aligning disc holes in the alignment disc with a different set of alignment holes in a circular pattern of frame holes in the frame.

### BRIEF DESCRIPTION OF THE DRAWINGS

FIG. 1 shows a perspective view of a frame of an equipment mounting apparatus;

FIG. 2 shows a top view thereof;

FIG. 3 shows a front view thereof;

FIG. 4 shows a side-view thereof;

FIG. 5 shows a rear view thereof;

FIG. 6 shows a perspective view of an alignment ring;

FIG. 7 shows a perspective view of an alignment disc;

FIG. 8 shows a perspective view of an equipment mounting apparatus assembly;

FIG. 9 shows an exploded perspective view of an equipment mounting apparatus assembly;

FIG. 10 shows a side perspective view of an equipment mounting apparatus assembly attached to an excavator arm;

FIG. 11 shows a side perspective view of an equipment mounting apparatus assembly attached to an excavator arm, in use, pitch, roll, and yaw shown;

FIG. 12 shows a top view of an equipment mounting apparatus assembly in a first position, with orientations of pitch, roll, and yaw shown;

FIG. 13 shows a top view of an equipment mounting apparatus assembly in a second position, with orientations of pitch, roll, and yaw shown.

### DETAILED DESCRIPTION

The specific embodiments given in the drawings and following description do not limit the disclosure. On the contrary, they provide the foundation for one of ordinary skill to discern the alternative forms, equivalents, and modifications that are contemplated by the inventors and encompassed in the claim scope.

The disclosed embodiments are best understood in the context of the larger environments in which they operate. In one embodiment, a frame 20 mounts to an excavator arm 120 via an arm bracket 100. A turntable type assembly is created by the alignment ring 30 being affixed in a static position to the top surface 22 of frame 20, with the rotatable alignment disc 15 sitting within the alignment ring 30. The alignment disc 15 is captured by the alignment ring 30, with the outer diameter of the alignment disc 15 larger than the open inner portion diameter of the alignment ring 30. A recess 38 on the interior circumference of the alignment ring 30 creates a space for the alignment disc 15, thereby capturing the alignment disc 15, while allowing the alignment disc 15 to be rotatable relative to the alignment ring 30.

Alignment disc 15 may include a plurality of disc holes 45, with one embodiment using four disc holes 45, the disc holes 45 arranged in rectangular pattern on disc 20. The frame 20 may include a circular pattern of frame holes 40, and alignment holes 45a, on the top surface 22 of the frame 20. The alignment disc 15 may be rotated in the alignment ring 30, with the disc holes 45 and the alignment holes 45a thereby aligning due to the alignment disc 15 being captured by the alignment ring 30. Fasteners such as bolts or other suitable type may then secure the alignment disc 15 in a rotated position relative to the alignment ring 30, for purposes which will be further detailed.

The frame assembly may mount in place of a bucket which may be detached from an excavator 135. A device such as a winch 140 may be affixed to the frame 20. An anchor point 28 may be positioned on the bottom surface 24 of the frame 20. The anchor point 28 may be used to penetrate the ground, and provide bracing force needed by the winch 140 when the winch cable is under tensile load. The turntable type assembly allows the winch 140 to be positioned at different angles relative to the excavator arm 120 (and therefore the main cab/track portion of the excavator). This allows the winch 140 (via the frame 20) to anchor into the ground, and be adjusted/positioned for a straighter pulling angle without the need to reposition the excavator 135.

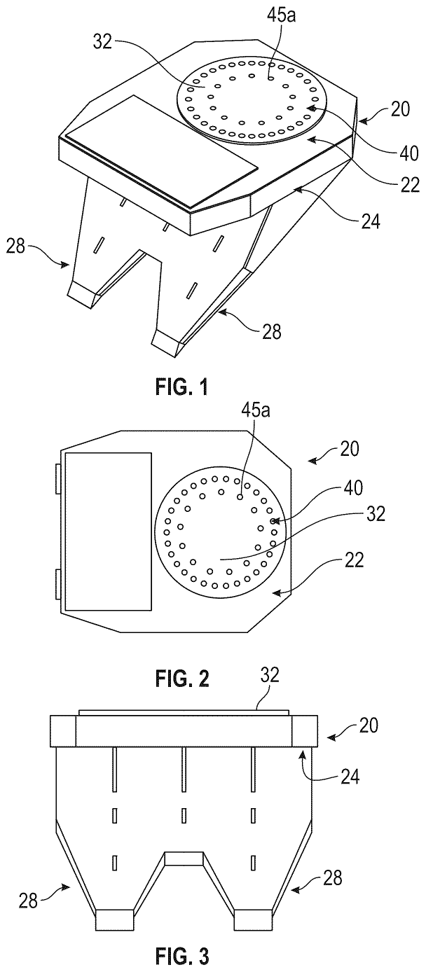

The accompanying drawings illustrate one embodiment of the present disclosure. Accordingly, FIG. 1 shows a perspective view of an equipment mounting apparatus frame 20. A circular pattern of alignment ring mounting holes 40 is seen in frame 20′s top surface 22, and an anchor point 28 attached to its bottom surface 24. A reinforcement plate 32 may be present on the top surface 22 of frame 20. The frame 20 provides a structural platform for mounting equipment such as a winch 140 and for transferring loads from the mounted equipment to the excavator arm 120 and into the ground via the anchor point 28. The circular pattern of alignment holes 45a enables the rotational adjustment capability of the equipment mounting apparatus by providing multiple positions at which the alignment disc 15 can be secured.

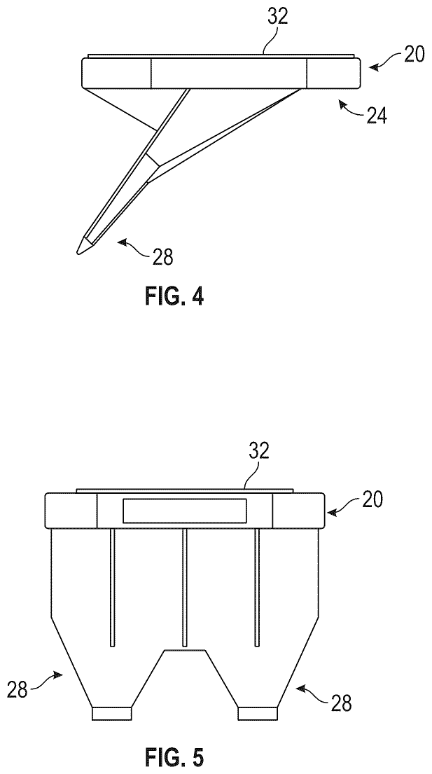

FIG. 2 shows a top view of frame 20, clearly illustrating the circular pattern of alignment ring mounting holes 40 and alignment holes 45a, both arranged concentrically. FIG. 3 shows a front view of frame 20, depicting the anchor point 28 extending from the bottom surface 24. FIG. 4 shows a rightside view of frame 20, further illustrating the relationship between the top surface 22, bottom surface 24, and anchor point 28. FIG. 5 shows a rear view of frame 20. These views collectively demonstrate the structural configuration of the frame 20 and the positioning of the alignment ring mounting holes 40, alignment holes 45a, and anchor point 28 relative to the frame 20′s overall geometry.

Frame 20′s top surface 22 and bottom surface 24 made be joined by side pieces along the perimeter, with a box-type configuration that's forms a hollow cavity inside. The frame may be constructed of appropriate material such as, but not limited to, plate steel, and utilize welded joints.

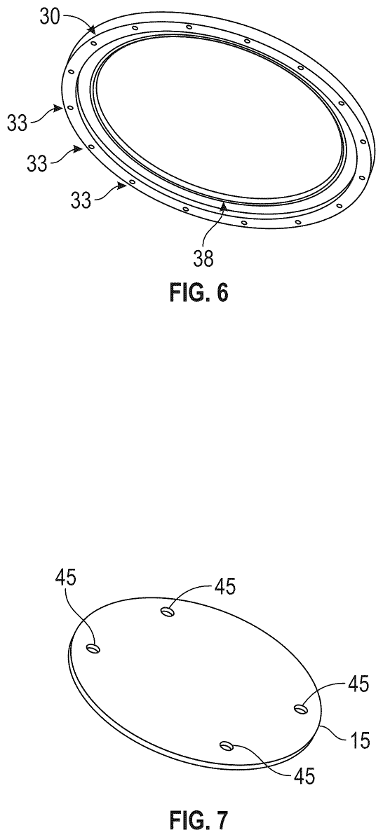

FIG. 6 shows alignment ring 30 in perspective view. The alignment ring 30 includes a recess 38 on its interior circumference. The recess 38 is configured to receive and capture the alignment disc 15 while permitting rotational movement. The alignment ring 30 may be bolted to the top surface 22 of the frame 20 in a position to align with the circular pattern of alignment ring mounting holes 40, or it may be welded or otherwise permanently affixed in place.

FIG. 7 shows alignment disc 15 in perspective view. The alignment disc 15 includes a plurality of disc holes 45 arranged in a pattern that corresponds to the circular pattern of alignment holes 45a in the frame 20. In the illustrated embodiment, four disc holes 45 are positioned in a rectangular pattern on the alignment disc 15. The alignment disc 15 has an outer diameter sized to be captured within the recess 38 of the alignment ring 30 while being larger than the inner opening of the alignment ring 30, thereby preventing the alignment disc 15 from passing through the alignment ring 30 while allowing rotational movement.

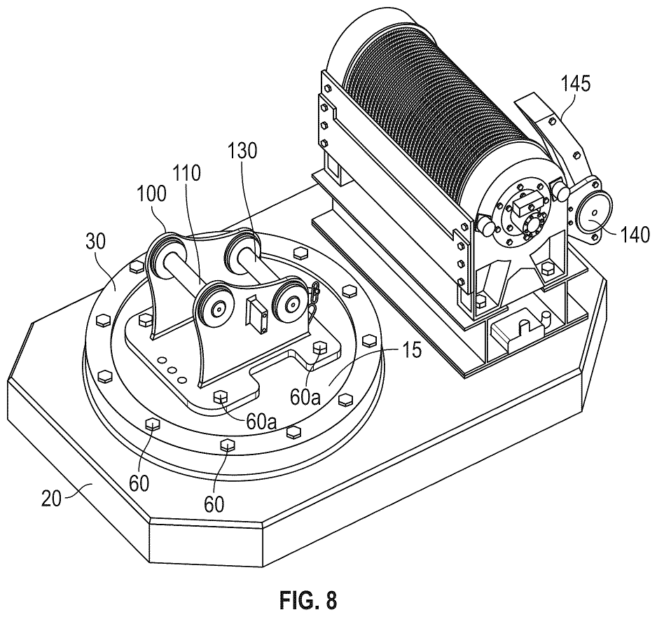

When assembled, the alignment ring 30 and alignment disc 15 are configured so that the alignment ring 30 captures the alignment disc 15, allowing the alignment disc 15 to rotate relative to the alignment ring 30. FIG. 8 shows an equipment mounting apparatus assembly in which the recess 38 on the interior circumference of the alignment ring 30 captures the alignment disc 15, as the alignment ring 30 is affixed to the frame 20. Alignment ring 30 may be positioned over reinforcement plate 32, though the latter component is optional. Ring fasteners 60 (in a circular pattern) may secure alignment ring 30 to frame 20, or the ring 30 and frame 20 may be joined by other methods such as welding.

Disc fasteners 60a, of which four are used in one embodiment, pass through disc holes 45 (in alignment disc 15), and into alignment holes 45a in frame 20. Alignment holes 45a may be threaded to accept threaded-type (such as bolts) disc fasteners 60a. Other suitable types of removable fasteners other than threaded types may also be used. The hollow architecture of frame 20 allows access to underside of top surface 22, such that the bottom of alignment holes 45a can be accessed. This allows alignment holes 45a to be unthreaded straight bores if desired, with disc fasteners 60a secured by nuts.

This configuration allows the alignment disc 15 to be rotatable within the alignment ring 30. An arm bracket 100 is shown attached to the alignment disc 15, and a winch 140 is shown mounted to the top surface 22 of frame 20. Winch 20 may be mounted to frame 20 with suitable methods such as bolts, brackets, etc. This assembly creates a turntable-type mechanism that enables yaw adjustment of the frame 20 and any equipment mounted thereto relative to the excavator arm 120. FIG. 8 also shows fairlead 145, which is a typical component on winches known in the art, and optionally may be included on the present system.

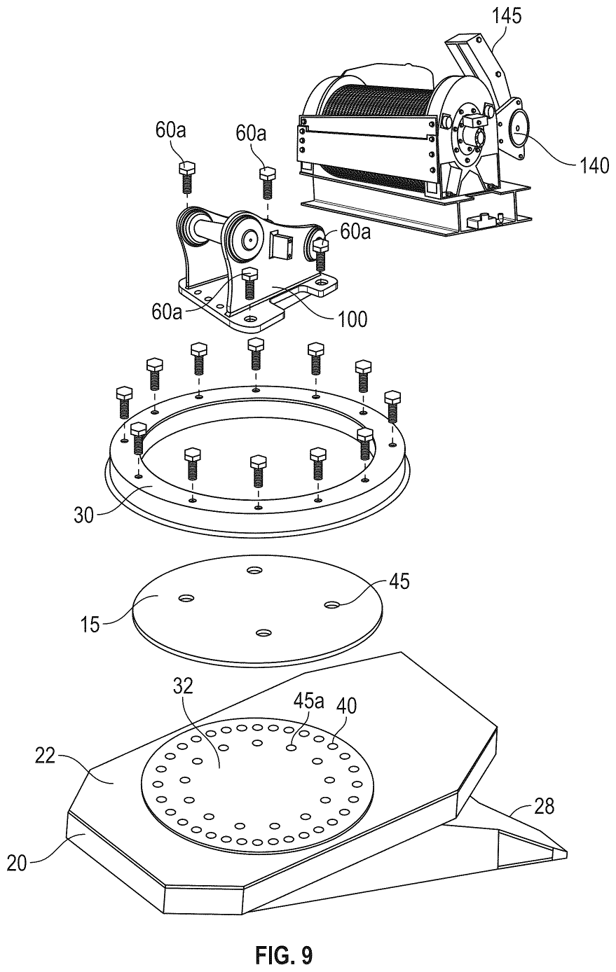

FIG. 9 is an exploded perspective view of the equipment mounting apparatus assembly, showing the spatial relationships and assembly sequence of the components. The exploded view illustrates how the alignment ring 30 is positioned on the top surface 22 of the frame 20 concentric with the circular pattern of alignment ring mounting holes 40, how the alignment disc 15 is captured within the alignment ring 30, and how the arm bracket 100 attaches to the alignment disc 15 and frame 20. This view demonstrates the modular nature of the equipment mounting apparatus and the manner in which the rotational adjustment mechanism is integrated into the overall assembly.

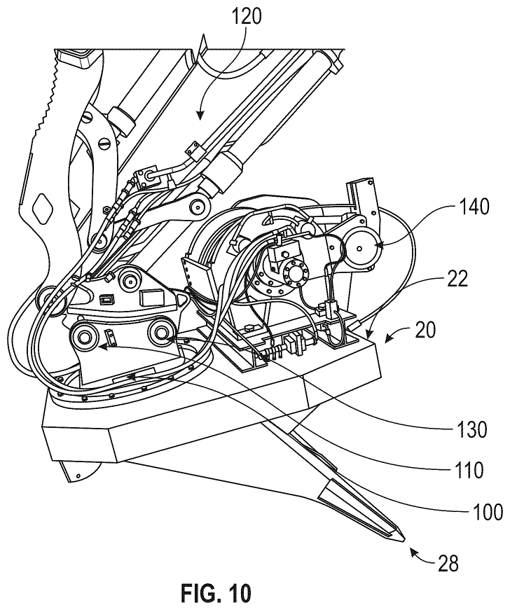

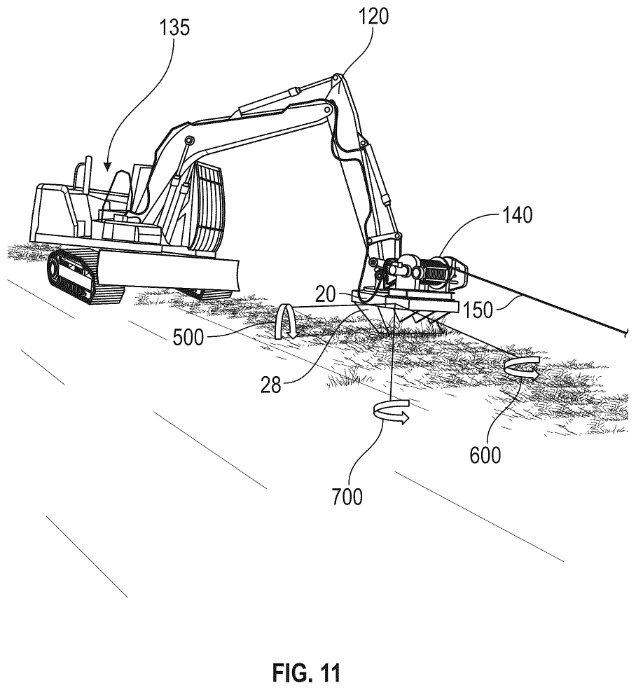

FIG. 10 shows a side view of the equipment mounting apparatus assembly attached to an excavator arm 120. The arm bracket 100 includes a first portion 110 and second portion 130 that allow it to be removably attachable to an end of the excavator arm 120. Such arm brackets and standard parts known in the art. Arm bracket 110 may utilize a quick-attach mechanism or other suitable attachment means compatible with the excavator arm 120. Arm bracket 100 is affixed to the frame 20′s top surface 22 via the alignment disc 15 and alignment ring 30 assembly. Winch 140 is shown affixed to the frame 20′s top surface 22. The anchor point 28 extends downward from the bottom surface 24 of the frame 20. This configuration allows the equipment mounting apparatus to replace a bucket or other attachment on the excavator arm 120 and provide a stable mounting platform for the winch 140 with rotational adjustability.

FIG. 11 shows a side perspective view of the equipment mounting apparatus assembly attached to the excavator arm 120, in use. The orientations of pitch 500, roll 600, and yaw 700 are indicated. A rotated position of the frame 20 (and therefore the winch 140) relative to the excavator arm 120 can be seen. Thus, the winch 140 may be aligned according to the desired pull angle of cable 150, without repositioning the excavator 135. The anchor point 28, partly obscured in this view, is dug into the ground, providing bracing when the winch 140 is in use pulling a load. This demonstrates the practical advantage of the equipment mounting apparatus: the ability to adjust the winch 140′s pull angle as needed without requiring repositioning of the entire excavator, which may not be feasible or possible depending on terrain conditions, obstacles, or other operational constraints.

In the present system, winch 140 and frame 20 adjustability relative to the excavator arm 120 is in a planar, or yaw angle orientation, as in yaw 700. That is, an excavator arm 120 movable in typical stick-and-boom motion may be considered pitch adjustment 500, and thus may move the frame 20 in a corresponding pitch manner. One embodiment of this application pertains to excavator arms 120 which are not adjustable (relative to, for instance, a traditional bucket or shovel) in roll 600 or yaw 700 orientations. An embodiment of the present application allows adjustment between the excavator arm 120 and frame 20 in yaw 700, but not in roll 600. This yaw 700 adjustment is accomplished through rotation of the alignment disc 15 within the alignment ring 30, with the arm bracket 100 and alignment disc 15 being rotatably positionable relative to the frame 20 and then secured in a desired position using fasteners placed through the disc holes 45 and alignment holes 45a.

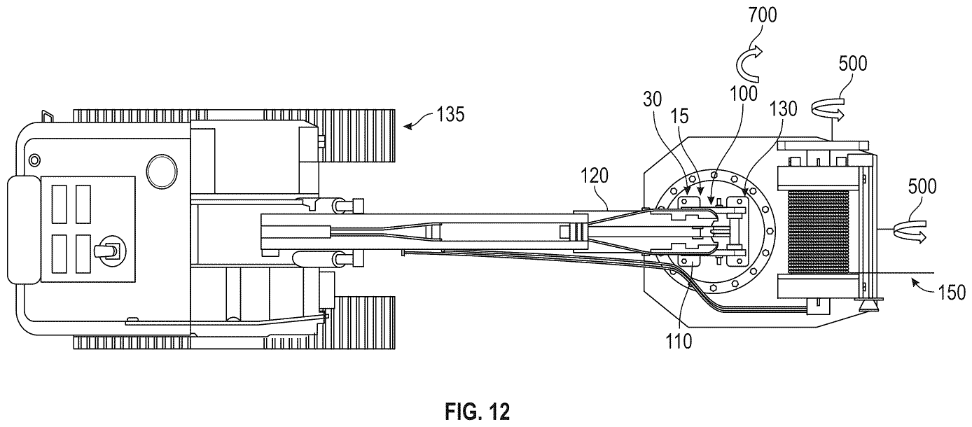

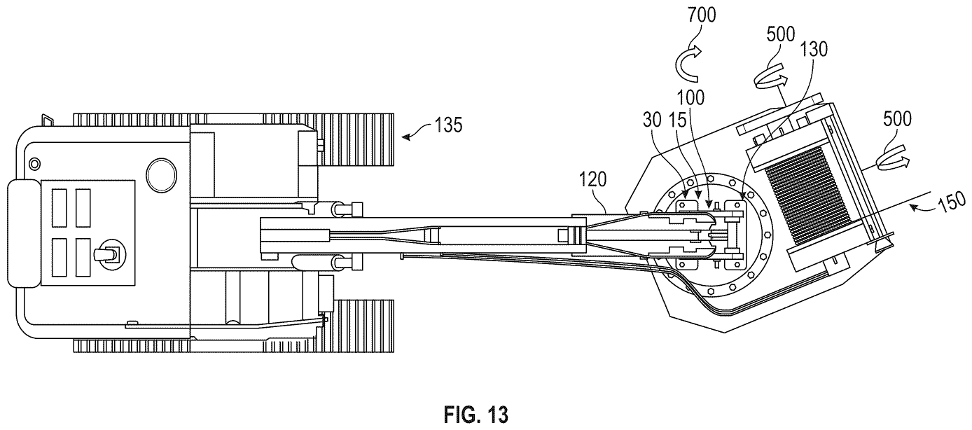

FIG. 12 shows a top view of the equipment mounting apparatus assembly in a first position, with orientations of pitch 500 and yaw 700 shown. The alignment disc 15 and arm bracket 100 are positioned at a first rotational orientation relative to the frame 20. The disc holes 45 in the alignment disc 15 are aligned with a first set the circular patterned alignment holes 45a frame 20, and disc fasteners 60a secure the alignment disc 15 in this first position. This first position may correspond to a particular pull angle required for a winching operation.

FIG. 13 shows a top view of the equipment mounting apparatus assembly in a second position, with orientations of pitch, roll, and yaw shown. The alignment disc 15 and arm bracket 100 are positioned at a second rotational orientation relative to the frame 20, different from the first position shown in FIG. 12. The disc holes 45 in the alignment disc 15 are now aligned with a different set of circular patterned alignment holes 45a frame 20, and disc fasteners 60a secure the alignment disc 15 in this second position. This demonstrates the adjustability of the equipment mounting apparatus, allowing the operator to reposition the frame 20 and winch 140 relative to the excavator arm 120 by removing the disc fasteners 60a, rotating the alignment disc 15 within the alignment ring 30 to a new position, and reinstalling the disc fasteners 60a through a different set of aligned disc holes 45 and alignment holes 45a. The number of available positions is determined by the number and spacing of the frame holes 40 in the circular pattern.

The equipment mounting apparatus provides numerous technical advantages. First, it enables yaw adjustment of mounted equipment such as a winch 140 relative to an excavator arm 120 without requiring repositioning of the entire excavator 135, which can be time-consuming and may not be possible in confined spaces or difficult terrain. Second, the turntable-type assembly created by the alignment ring 30 and alignment disc 15 provides a robust rotational mechanism that can withstand the substantial loads imposed during winching operations. Third, the anchor point 28 integrated into the frame 20 allows the equipment mounting apparatus to transfer winching loads directly into the ground, providing stable bracing without relying solely on the excavator's weight and stability. Fourth, the circular pattern of alignment holes 45a provides multiple discrete rotational positions, allowing fine adjustment of the pull angle while maintaining secure fastening at each position.

Although the present system has been described with respect to one or more embodiments, it will be understood that other embodiments of the present system may be made without departing from the spirit and scope of the present system. Various modifications and variations can be made to the disclosed embodiments. For example, the number and arrangement of disc holes 45 and alignment holes 45a can be varied to provide different numbers of rotational positions or different angular increments between positions. The anchor point 28 may take various forms, such as a spike, blade, or other ground-penetrating structure. The frame 20 may be configured to mount different types of equipment beyond winches, such as augers, grapples, or other attachments that benefit from yaw adjustability. The arm bracket 100 may be adapted to interface with different types of excavator quick-attach systems or other mounting mechanisms. The alignment ring 30 and alignment disc 15 may incorporate bearings, bushings, or other elements to facilitate smooth rotation and reduce wear.

We claim:

1. An equipment mounting apparatus, comprising:
a frame that includes an alignment ring attached to a top surface of the frame, and an anchor point attached to a bottom surface of the frame;
the alignment ring configured to capture an alignment disc and allow the alignment disc to rotate relative to the alignment ring, the alignment ring capable of receiving an arm bracket;
the top surface of the frame containing a circular pattern of alignment holes positioned below and concentric to the alignment disc;
the alignment disc including at least two disc holes that align with the circular pattern of alignment holes in the frame; and
the alignment disc being rotatably positionable relative to the frame and reversibly affixable in position with fasteners placed through the disc holes and alignment holes to enable a yaw adjustment of the alignment disc relative to the frame.

2. The apparatus of claim 1, in which the alignment disc includes four disc holes arranged in a rectangular pattern on the alignment disc.

3. The apparatus of claim 1, in which the alignment ring includes a recess on an interior circumference of the alignment ring, the recess configured to receive and capture the alignment disc.

4. The apparatus of claim 1, in which the alignment disc has an outer diameter larger than an inner opening diameter of the alignment ring to prevent the alignment disc from passing through the alignment ring while allowing rotational movement.

5. The apparatus of claim 1, in which an arm bracket is mounted to the alignment ring.

6. The apparatus of claim 1, in which a winch is mounted to the top surface of the frame.

7. The apparatus of claim 6, in which the anchor point is configured to penetrate ground and provide bracing force when a winch cable of the winch is under tensile load.

8. The apparatus of claim 1, in which the arm bracket is attachable to an arm of an excavator.

9. The apparatus of claim 1, in which the alignment ring is bolted to the top surface of the frame.

10. The apparatus of claim 1, in which the circular pattern of alignment holes provides multiple discrete rotational positions for the alignment disc.

11. An equipment mounting system for an excavator, comprising:
an excavator arm;
a frame having a top surface and a bottom surface;
an alignment ring affixed to the top surface of the frame;
an alignment disc captured within the alignment ring and rotatable relative to the alignment ring;
an arm bracket having a first portion removably attached to an end of the excavator arm and a second portion affixed to the alignment disc;
a plurality of disc holes in the alignment disc configured to align with a circular pattern of alignment holes;
an anchor point extending from the bottom surface of the frame; and
the top surface of the frame capable of receiving a winch;
the alignment disc being rotatably positionable to align the disc holes with different sets of alignment holes to enable a yaw adjustment of the frame and winch relative to the excavator arm without repositioning the excavator.

12. The system of claim 11, in which the alignment ring includes a recess on an interior circumference that captures the alignment disc while permitting rotational movement.

13. The system of claim 11, in which the plurality of disc holes comprises four disc holes.

14. The system of claim 11, in which the anchor point is configured to penetrate ground and transfer winching loads into the ground.

15. The system of claim 11, in which the alignment disc is secured in a selected rotational position by disc fasteners extending through the disc holes and into the alignment holes.

16. The system of claim 11, in which each alignment hole is threaded to engage with a disc fastener.

17. The system of claim 11, in which the circular pattern of alignment holes provides a plurality of discrete angular positions for the frame relative to the excavator arm.

18. A method of adjusting a pull angle of a winch mounted on an excavator, comprising:
providing an equipment mounting apparatus comprising a frame with an alignment ring affixed to a top surface of the frame, an alignment disc captured within the alignment ring, an arm bracket attached to the alignment disc and removably attached to an excavator arm, and a winch mounted to the top surface of the frame;
removing disc fasteners securing the alignment disc in a first rotational position relative to the frame;
rotating the alignment disc within the alignment ring to a second rotational position relative to the frame to adjust a yaw angle of the frame and winch relative to the excavator arm; and
installing fasteners through disc holes in the alignment disc and alignment holes in the frame to secure the alignment disc in the second rotational position.

19. The method of claim 18, further comprising penetrating ground with an anchor point extending from a bottom surface of the frame to provide bracing during winching operations.

20. The method of claim 18, rotating the alignment disc comprising aligning disc holes in the alignment disc with a different set of alignment holes in a circular pattern of frame holes in the frame.
